(19) United States
(12) Patent Application Publication
(10) Pub. No.: US 2011/0278801 A1
(43) Pub. Date: Nov. 17, 2011

(54) NECK SEAL

(75) Inventors: Thomas C. Wojtkowski, JR., Shrewsbury, MA (US); Peter N. Osgood, Westborough, MA (US)

(73) Assignee: MORGAN CONSTRUCTION COMPANY, Worcester, MA (US)

(21) Appl. No.: 12/777,362

(22) Filed: May 11, 2010

(51) Int. Cl. F16J 15/32

(52) U.S. Cl. 277/559

(57) ABSTRACT

A seal is disclosed for use in a rolling mill oil film bearing in which a sleeve is mounted on a roll neck for rotation therewith, the sleeve is journalled for rotation in a fixed bushing, and a flow of oil exits from between the sleeve and the bushing. The seal comprises a flexible circular seal body adapted to be mounted on and to rotate with the roll neck. Circumferentially spaced impellers project from the seal body. The impellers are rotatable with the seal body and serve to rotatively propel oil exiting from between the sleeve and bushing.

### BACKGROUND OF THE INVENTION

1. Field of the Invention

This invention relates to systems used in rolling mill oil film bearings to remove laminar flows of oil exiting tangentially from between the rotating sleeves and the stationary bushings surrounding the sleeves, and is concerned in particular with a neck seal for use in such systems.

2. Description of the Prior Art

In a typical rolling mill oil film bearing, a sleeve surrounds and is rotatable with a roll neck. The sleeve is journalled for rotation within a fixed bushing contained in a chock. The sleeve and bushing are dimensioned to define a gap therebetween. During operation, oil is introduced continuously into the gap where it is rotatably urged into a hydrodynamically maintained film between the sleeve and bushing at the load zone of the bearing. Laminar flows of oil exit tangentially from each end of the bearing into sumps from which the oil is removed by gravity for filtering and cooling before being recirculated back to the bearings.

A drawback of this arrangement is that large diameter drain lines are required to accommodate the gravity flow of oil exiting from the bearings. These drain lines occupy an inordinate amount of exterior space and thus contribute disadvantageously to the overall size of the bearing. Care must also be taken to insure that the drain lines are properly installed with pitches designed to prevent oil from backing up into and flooding the bearing sumps.

### SUMMARY OF THE INVENTION

In an improved system described in a copending application, the kinetic energy of rotating bearing components is employed to pump oil out of the bearings. Because the oil is forcibly expelled, smaller drain lines may be employed to handle the exiting oil flow, without the need to maintain the drain pitches required to accommodate gravity flow.

The present invention is directed to an improved neck seal adapted to be mounted on and to rotate with the roll neck. The neck seal coacts with other bearing components to define an annular chamber arranged to receive the laminar flow of oil exiting from between the sleeve and bushing. The annular chamber has a tangential outlet, and the oil is rotatively driven around the chamber and out through the outlet by impellers carried by the neck seal.

These and other features and advantages of the present invention will now be described in further detail with reference to the accompanying drawings, wherein:

### BRIEF DESCRIPTION OF THE DRAWINGS

FIG. 1 is a cross sectional view through a rolling mill oil film bearing embodying a neck seal in accordance with the present invention;

FIG. 2 is an enlarged view of the circled area marked “A” in FIG. 1;

FIG. 3 is a perspective view of the neck seal shown in FIGS. 1 and 2;

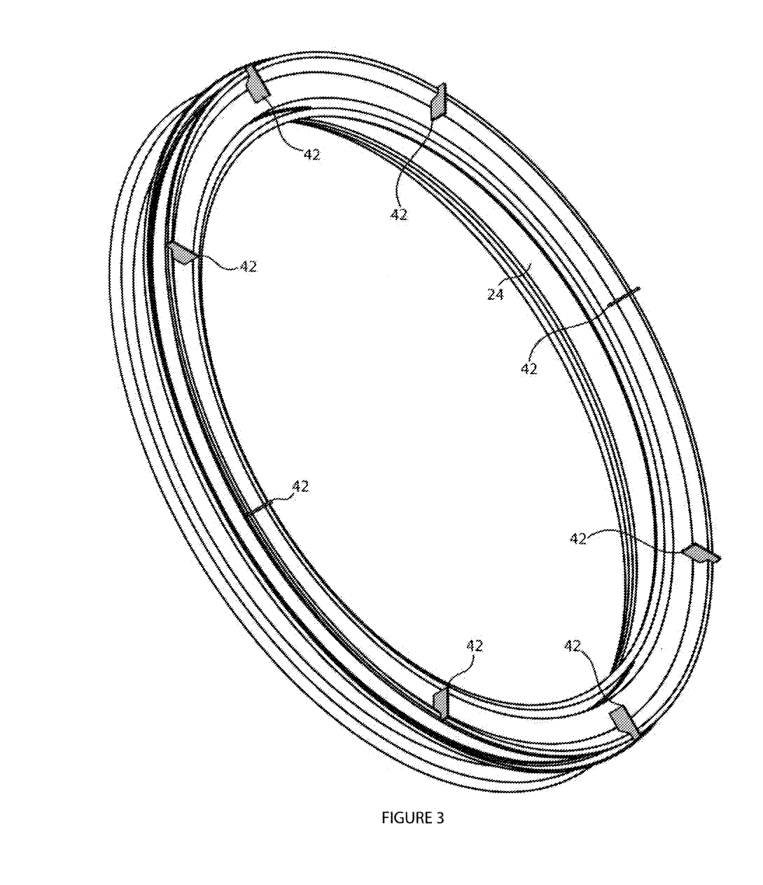

FIG. 4 is a view of the outboard side of the neck seal; and

FIG. 5 is across sectional view taken through the seal end plate extension.

### DETAILED DESCRIPTION

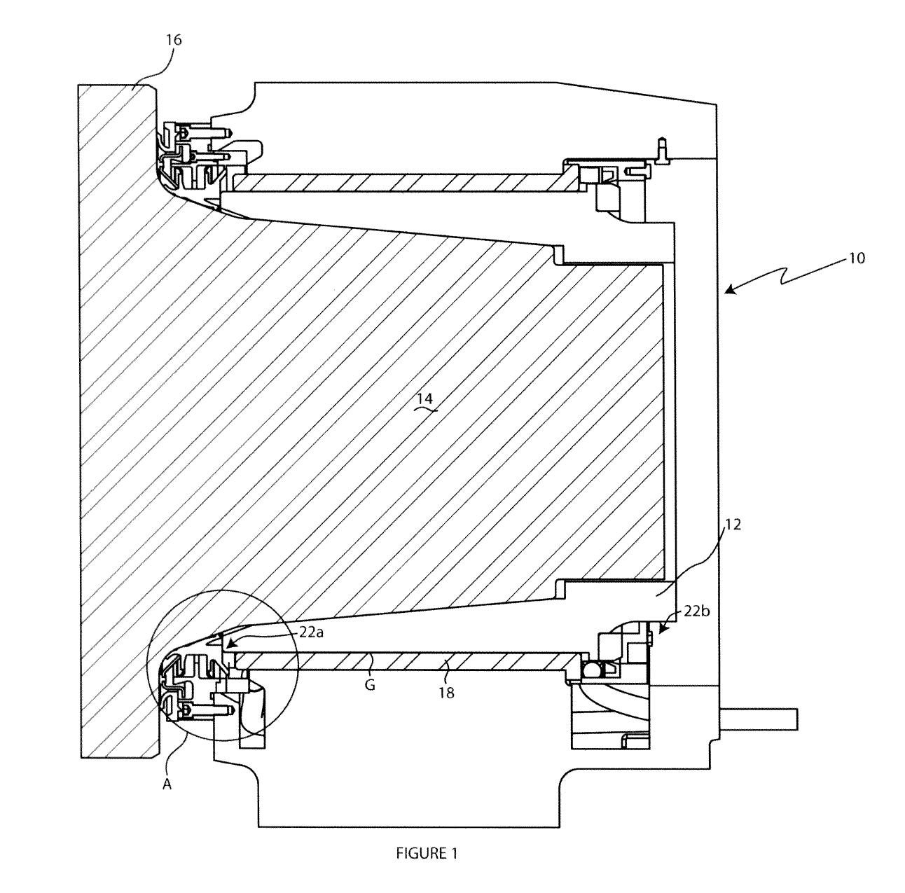

With reference initially to FIG. 1, a rolling mill oil film bearing is generally indicated at 10. The bearing includes a sleeve 12 fixed to the tapered neck 14 of a roll 16. The sleeve is journalled for rotation in a fixed bushing 18 contained within a chock 20. The sleeve and bushing are dimensioned to define a gap “G” therebetween. During operation, oil is introduced continuously into the gap where it is rotationally urged by the sleeve into a hydrodynamically maintained film between the sleeve and bushing at the load zone of the bearing. Laminar flows of oil exit tangentially from opposite ends of the bearing.

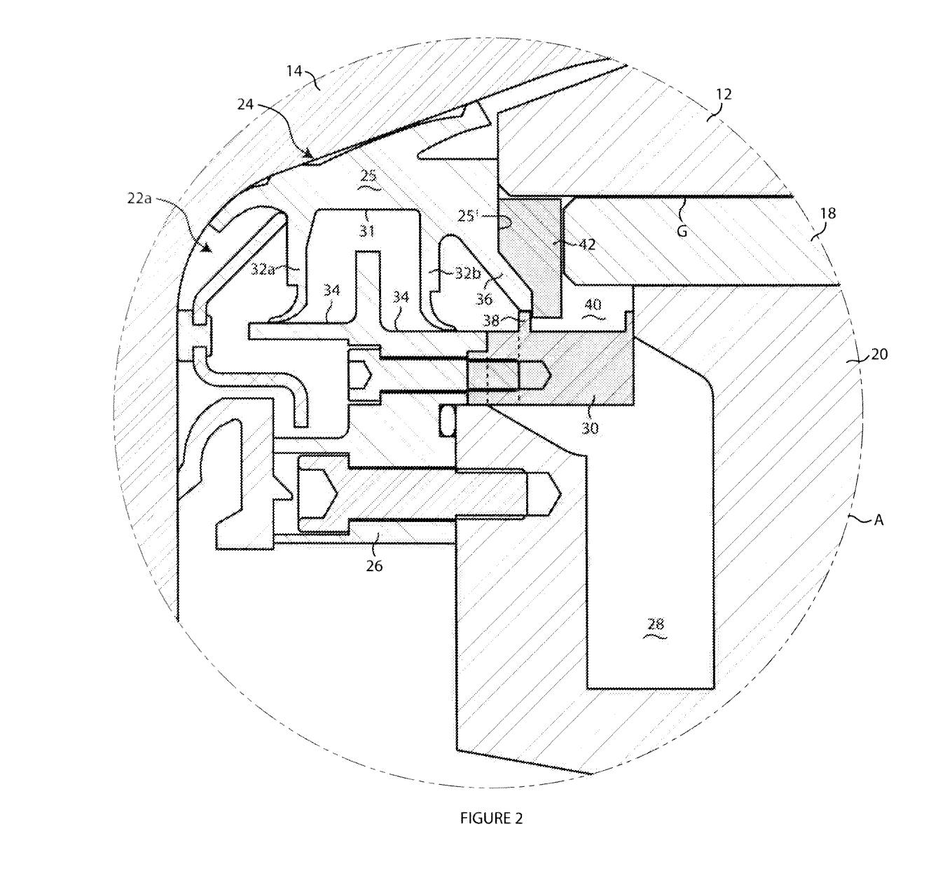

Seal assemblies 22a, 22b are located respectively at the inboard and outboard ends of the bearing. With additional reference to FIG. 2, it will be seen that the inboard seal assembly 22a includes a flexible and resilient neck seal 24 in accordance with the present invention. The neck seal includes a flexible circular seal body 25 mounted on the tapered roll neck section 14 for rotation therewith along with the sleeve 12. The neck seal is surrounded by a seal end plate 26 fixed to the chock 20. A circular extension 30 spans a gap between the seal end plate 26 and the chock 20.

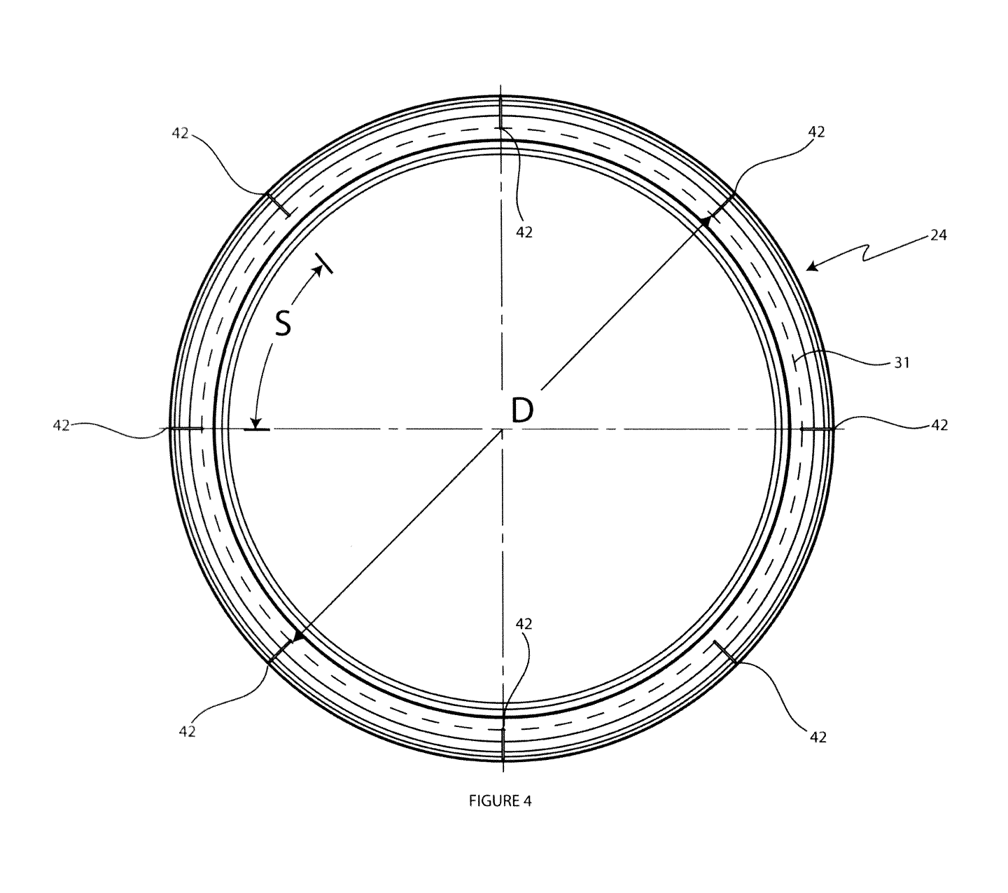

Axially spaced flanges 32a, 32b project radially outwardly from opposite ends of a cylindrical surface 31 on the neck seal body 25. The flanges 32a, 32b sealingly contact shoulders 34 on the seal end plate. An annular flinger 36 on the neck seal sealing contacts a circular shoulder 38 on extension 30. The flinger projects from the seal body at an obtuse angle with respect to an outboard end face 25′ of the seal body, and at an acute angle with respect to flange 32b. Confinement surfaces provided by the flinger 36, extension 30 and chock 20 cooperate with the sleeve 12 and hushing 18 to define an annular inboard chamber 40 isolated from a sump 28 and arranged to receive the laminar flow of oil exiting tangentially from the gap G between the sleeve and bushing. Impellers 42 project into the chamber 40 from the seal body 25 at the juncture of the flinger 36 and the end face 25′. As can be best seen by additional reference to FIG. 4, the impellers 42 are spaced around the circumference of neck seal 24, with the spacing “s” between the impellers being between about 4.9 to 39.3% of the outside diameter “D” of the seal body as measured at cylindrical surface 31.

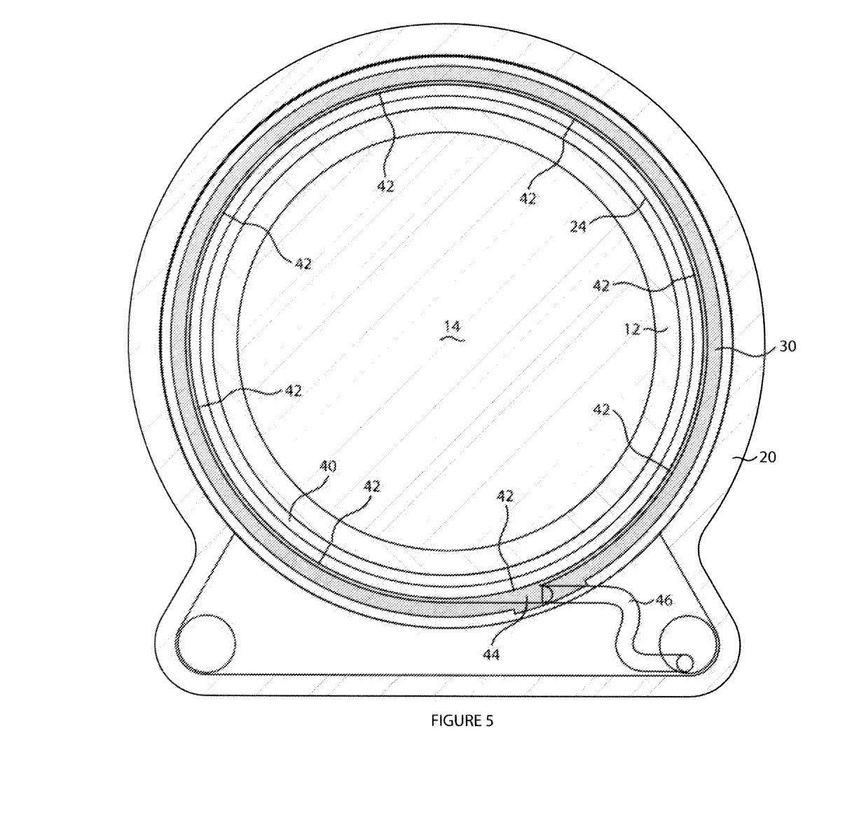

As shown in FIG. 5, the extension 30 includes an outlet 44 communicating tangentially with the annular chamber 40. A hose 46 is connected to the outlet 44 and leads to the exterior of the bearing for connection to a conventional mill lubrication system (not shown).

The outlet 44 is sized with respect to the volume of oil being received in the annular chamber 40 such that during steady state operation, that chamber remains filled with oil. As noted previously, both the seal 24 and sleeve 12 are mounted on and rotate with the roll neck 14. Thus, the impellers 42 carried by the seal 24 rotate with and at the velocity of the sleeve. In the cross sectional area of the annular chamber 40 spanned by the impellers 42, the oil is rotatively propelled at the velocity of the sleeve, thus serving to efficiently pump the oil around chamber 40 and out through the outlet 44.

It thus will be seen that the impellers 42 serve to harness the rotating kinetic energy of the neck seal 24 to exert a pumping action which forcibly ejects oil from the annular chamber 40. As noted above, by forcibly ejecting oil rather than relying on gravity flow, smaller diameter drain lines may be employed and strategically positioned without regard to the maintenance of gravity pitches.

We claim:

1. A seal for use in a rolling mill oil film bearing in which a sleeve is mounted on a roll neck for rotation therewith, the sleeve is journalled for rotation in a fixed bushing, and a flow of oil exits from between the sleeve and the bushing, said seal comprising: a flexible circular seal body adapted to be mounted on and to rotate with the roll neck; and, circumferentially spaced impellers projecting from said seal body, said impellers being rotatable with said seal body and serving to rotatively propel oil exiting from between the sleeve and bushing.

2. The seal of claim 1 wherein, surfaces of the thus mounted seal body coacts with surfaces of other bearing components to define an annular chamber arranged to receive said exiting flow of oil, and wherein said impellers serve to rotatively propel oil received in said chamber.

3. The seal of claim 1 wherein said impellers are integrally molded components of said seal body.

4. The seal of claim 1 wherein an annular flinger projects angularly from an end face of said seal body, and wherein said impellers project axially from a junction of said end face with said flinger flange.

5. A seal for use on a roll neck rotatably supported in an oil film bearing, said seal comprising:
a flexible circular seal body adapted to be mounted on and to rotate with the roll neck;
axially spaced annular flanges projecting radially outwardly from said seal body;
an end face on said seal body;
an annular flinger projecting said seal body at an obtuse angle with respect to said end face and at an acute angle with respect to one of said annular flange: and
circumferentially spaced impellers projecting axially from said seal body at a juncture of said flinger and said end face.

6. The seal of claim 5 wherein the circumferential spacing between said impellers is between about 4.9 to 39.3% of the outside diameter of said seal body.
